(19) United States
(12) Patent Application Publication
(10) Pub. No.: US 2004/0199482 A1
(43) Pub. Date: Oct. 7, 2004

(54) Systems and methods for automatic and incremental learning of patient states from biomedical signals

(76) Inventor: Scott B. Wilson, Del Mar, CA (US)

Correspondence Address: PAUL, HASTINGS, JANOFSKY & WALKER LLP, P.O. BOX 919092, SAN DIEGO, CA, 92191-9092, US

(21) Appl. No.: 10/830,177

(22) Filed: Apr. 21, 2004

Related U.S. Application Data
(63) Continuation-in-part of application No. 10/810,949, filed on Mar. 25, 2004.
Application No. 10/810,949 is a continuation of application No. 10/123,834, filed on Apr. 15, 2002, now Pat. No. 6,735,467.

(51) Int. Cl. G06N 3/08; G06F 15/18; G06G 7/00; G06N 3/02; G06E 3/00; G06E 1/00

(52) U.S. Cl. 706/25; 706/15; 706/20; 706/924

(57) ABSTRACT

Given a record of instrument values over time, a user can mark the record to select the values of particular instruments during particular time ranges. They can further indicate the events (states) associated with those values and time ranges. These markings define the topology of the PNN. The selected instruments define the input nodes of the PNN and the event(s) detected, define the class nodes wherein each event has a corresponding positive class node and a corresponding negative class node. Upon constructing the PNN, training cases may be added to further refine the knowledge of the neural network in a time efficient manner. Because the optimal value of sigma varies little over training set sizes, training cases may be incrementally added to the PNN, further adding to its recognition capabilities, without having to train the PNN on the new cases or re-train the PNN on the old cases. As such, patient specific neural networks may be created in a time and cost efficient manner.

### RELATED APPLICATIONS INFORMATION

This application claims priority as a continuation-in-part to U.S. Utility application Ser. No. 10/810,949, entitled “METHOD AND SYSTEM FOR DETECTING SEIZURES USING ELECTORENCEPHALOGRAMS,” filed Mar. 25, 2004, which is a continuation of U.S. application Ser. No. 10/123,834, filed on Apr. 15, 2001, entitled “METHOD AND SYSTEM FOR DETECTING SEIZURES USING ELECTROENCEPHALOGRAMS.”

### BACKGROUND

1. Field of the Invention

The present invention relates to the real-time and incremental learning of patient states from biomedical signals with advanced algorithms.

2. Background Information

Patient monitoring and diagnostic mechanisms form an integral part of a hospital information network. Medical monitoring and diagnostic equipment collect data concerning vital patient parameters such as blood pressure, heart rate, heart rhythm, and other crucial information. These conventional systems however, are only capable of analyzing data to determine whether predefined alarm conditions are present. For example, electroencephalogram (EEG) monitors are configured to analyze patient information and sound an alarm if the data analysis indicates that the patient is experiencing trouble. In response to the alarm, medical personnel reevaluate the information gathered by the EEG monitor and determine whether the state detected by the EEG monitor was a true positive occurrence or a false positive occurrence.

If, however, the occurrence is a false positive, current medial diagnostic equipment is not capable of learning from the misidentification. In other words, conventional equipment cannot use contemporaneous information in a real-time fashion in order to immediately detect future biomedical states. Rather, if the data appears unique enough, a cumbersome process is employed to transform the seemingly interesting data into a useable detection algorithm, such as a neural network. Although neural networks are extremely advantageous to the medical diagnostic community, the time frame between collecting the data and transforming the data into a usable context is extremely inefficient as described below.

The medical industry currently uses neural network capabilities to classify biomedical signals and develop algorithms that aid in detecting future biomedical states based on past biomedical data. However, the conventional process used to create these algorithms is time inefficient. Specifically, the biomedical signals are first gathered and classified by one or more human experts. The classified signals are then sent to an algorithm developer who determines the neural network features and topology. The developer must then train the neural network by repeatedly presenting input data to the neural network. Once trained, a “packaged” algorithm is sent from the developer to the customer. The customers ultimately use this algorithm with conventional medical diagnostic equipment to aid in detecting medical states. This process generally takes months, if not years, to complete. In addition to being inefficient, applying this conventional process to the analysis of biomedical signals from a single patient is uneconomical.

### SUMMARY OF THE INVENTION

In order to combat the above problems, the systems and methods described herein provide an optimized neural network capable of learning, in real-time, patient states from biomedical signals, with a high degree of reliability.

Given a record of instrument values over time, a user can mark the record to select the values of particular instrument features during particular time ranges. A user can further mark the record to indicate the states associated with the values and time ranges selected. These markings can be used to define the topology of a probabilistic neural network (“PNN”). The selected instrument features define the input nodes of the PNN and the type of events or states detected define the class nodes. The particular instrument values selected and their associated states define training cases, which are represented in the PNN as pattern layer nodes, one pattern layer node per training case absent compression. After construction of the PNN, additional training cases can be added in a time efficient manner as additional pattern layer nodes, to further refine the knowledge of the neural network. Because the optimal value of sigma varies little over training set sizes, training cases may be incrementally added to the PNN, further adding to its recognition capabilities, without having to train the PNN on the new cases or re-train the PNN on the old cases. As such, users may continue to train the neural network locally in a time and cost efficient manner. For example, in an embodiment used to detect medical events, users can customize a neural network to recognize signal patterns that are specific to particular patient, or patterns characteristic of entirely new classes of events such as a research project investigating EEG signal patterns of previously uncharacterized medical states.

In another embodiment of the present invention, the configuration of instruments used to define the input nodes of the PNN may be selected automatically. By constructing multiple PNN's based on the same training cases, but different configurations of instruments, a metric such as the classification error or the Bayesian Information Criterion (BIC) is used to determine which instrument configuration is the most optimal.

In yet another embodiment of the present invention, the neural network may be optimized by compressing the neural network such that similar patterns are merged and described by their centroid and weight.

In still another embodiment of the present invention, multiple neural networks can be combined to aggregate the learning contained in each. Specifically, neural networks having the same input and summation layers may be combined by summing the pattern nodes. For example, neural networks created for specific patients may be combined with other patient-specific neural networks to create a more robust neural network.

In another embodiment, a client server architecture can be utilized to create and enhance a centrally stored neural network. Client and server mechanisms connected through a network are configured with the necessary hardware and software to perform the incremental update, compression and combination functions thus allowing the centrally stored neural network to be supplemented and enhanced with training cases from numerous clients

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is a diagram illustrating a probabilistic neural network;

FIG. 2 is a diagram illustrating a typical arrangement of electrodes positioned on the scalp of an epilepsy patient;

FIG. 3 shows a typical montage of an EEG recording with nineteen channels of voltage waveforms and four instruments;

FIG. 4 is a flow chart illustrating the method of constructing a PNN using a manual selection of instruments;

FIG. 5 is a screenshot illustrating the use of a Template instrument for registration of spikes in a record;

FIG. 6 is a screenshot of the software program configured to create a PNN topology through the selection of instruments, events and time ranges;

FIG. 7 is a flow chart describing the neural network training process set forth in FIG. 4;

FIG. 8 is a flow chart describing a method of determining a configuration of instruments from a set of available instruments;

FIG. 9 is a flowchart describing the incremental learning process of the neural network;

FIG. 10 is a flow chart illustrating a method of updating a neural network based on training cases;

FIG. 11 is a flow chart illustrating a method of compressing a neural network;

FIG. 12 is a flow chart illustrating a method of combining a plurality of neural networks; and

FIG. 13 is a block diagram illustrating a computer system for processing biomedical recordings to support automatic and incremental learning according to the present invention.

### DETAILED DESCRIPTION OF THE PREFERRED EMBODIMENTS

In the descriptions of example embodiments that follow, implementation differences, or unique concerns, relating to different types of systems will be pointed out to the extent possible. It should be understood that the methods described herein may be implemented in hardware or software that may be utilized with any type of computer or network system.

The present invention's optimally trained neural network having real-time and incremental learning capabilities may be utilized to perform pattern recognition in any system that generates data as a function of time, including any medical diagnostic apparatus or process. Therefore, the scope of the present invention should not be limited to EEG's or even the medical field. However, for explanatory purposes only, this application describes the neural network and its learning capabilities within the context of detecting patient states using biomedical data detected by EEG's.

Various biomedical signals, including but not limited to, the electroencephalogram (EEG), electrocardiogram (ECG), heart rate and blood pressure are used to monitor patient states such as seizure, stroke, or heart attack. As expected, voluminous amounts of critical data may be derived from these signals. Therefore, an efficient and accurate process is needed for synthesizing the information to determine the occurrence of particular patient states such as a seizure or heart attack.

The processing of such information is often handled by neural networks such as multilayer perceptrons (MLP). A neural network is a data modeling tool capable of capturing and representing relationships. In order to be optimally trained to support incremental learning capabilities, an optimally trained neural network must have the following properties: (1) fast training, (2) fast (real-time) prediction (classification), (3) does not require an initial guess for the neural network topology (e.g., number of hidden nodes) or other user-supplied parameters, and (4) allow training on new data without requiring previous data to be available. The kernel-based Probabilistic Neural Network (PNN) and Generalized Regression Neural Network (GRNN) models support each of these properties.

Conventional neural networks such as MLP's do not support fast training for large amounts of data. In addition, defining the network topology of an MLP is a difficult problem because an MLP's topology can be arbitrary (subject to the constraints that the number of input and output nodes are fixed), but differences in topology may affect performance in unpredictable ways. This problem is not easily solvable by automated processes, but instead often involves some level of human judgment.

In addition, MLP's cannot incorporate new data without retraining, and such training requires that both the new and old data be available. As is known to persons of ordinary skill in the art, MLP training consists of numerous iterations of propagation algorithms through all of the training cases, requiring high amounts of processing time. MLP's do not support incremental learning, meaning training on new training cases but not old, because the link weights in an MLP are updated a very small amount in each iteration. Training on new training cases alone results in an MLP learning the new training cases but “forgetting” the old ones. In practical terms, an MLP must retrain from scratch to effectively learn new training cases, which can take minutes if not hours and which generally cannot be performed in real-time. “Retraining” as used herein refers generally to any process for incorporating new training cases into a classification system that requires nontrivial computation. Within the context of a MLP, “retraining” specifically refers to the iterative propagation process referred to above. In the context of a PNN, “retraining” refers to the process of calculating an optimal kernel width value, by searching to minimize prediction error as described below, but excludes the determination of an approximate kernel width value by simple heuristics as also described below.

The use of kernel-based neural networks (NNs) such as Probabilistic Neural Network (PNN) and the Generalized Regression Neural Network (GRNN) overcome the deficiencies associated with traditional MLP neural networks. Most importantly, kernel-based NNs, unlike other neural networks, support automatic, real-time and incremental learning. For explanatory purposes only, the application describes in detail the use of the PNN, which is used for classification problems. Virtually identical steps are required to solve regression problems by using the GRNN.

Fundamentally, a neural network is simply a function, which generates one or more output values, from one or more input values (collectively an input state). The possible output values of a PNN are limited to discrete integers, while the possible output values of a GRNN are a continuous range of real numbers. Thus, while a PNN's output range is limited to a discrete number of values (classes), a GRNN can output an infinite number of values, such as any number between the values 0.1 and 1.0.

Neural networks can be used as classification systems. In a system that generates discrete output values such as a PNN, each discrete output value can indicate a different class representing a distinct type of medical state or event. In some embodiments, neural network output values might correspond directly to particular medical states such as seizures. For example, PNN output values 2, 1, and 0 might represent the medical state/event types “seizure,” “heart attack,” and “healthy,” respectively. Alternatively, PNN output values 2, 1, and 0 might represent “grand mal seizure,” “epileptic seizure,” and “no seizure,” respectively. In a system that generates continuous output values such as a GRNN, the output values can be grouped into classes according to thresholds and/or ranges of possible output values. For example, GRNN output values less than 1.0 might represent “no seizure” while output values greater than 1.0 represent “seizure.”

Alternatively, a neural network might “classify” input states only impliedly based on other systems to which they attached, such as where a GRNN output value is monitored by an alarm, which goes off if the output value exceeds a certain threshold. In such configurations, the neural network simply generates output values which are then evaluated and classified by downstream systems.

Alternatively, neural networks can be used to mimic the behavior of other medical equipment. For example, a GRNN can be used to mimic an expensive piece of equipment that is only present in limited locations and which has continuous output value ranges. Once the GRNN has trained on enough of the expensive equipment's output values to provide a fair approximation, that GRNN can be stored and distributed as lower-cost version of the expensive instrument, which can later serve as an input to downstream classification system such as a PNN.

A PNN operates by representing each training case as a separate probability density curve. A user can configure a PNN to use a particular type of probability density curve, such as the Gaussian curve. The density curves for all of the training cases in a particular class are summed to create a (estimated) probability density function representing the class as a whole. A new data point is classified by applying the estimated probability function corresponding to each class. The functions return an estimated probability that the new data point is a member of that class. The PNN selects the class with the highest probability. Effectively, this method selects the class having the highest sample density in the vicinity of the new data point. Prior probabilities can be used to weigh the class densities to allow preferential treatment of specific classes. This is important in two situations. First, the partition of training cases does not represent the expected class frequency. As such, the PNN may be trained with an equal number of seizure and non-seizure training cases, although the prevalence of seizure activity is much less than that of non-seizure activity in an actual EEG record. In this case, a greater weight is given to the non-seizure prior probability. Secondly, there may be a greater cost for incorrectly classifying particular events. Therefore, it may be advantageous to have some false positive detections than to miss seizures. In this case, a greater weight is given to the seizure prior probability. Often, both of these conditions apply and the prior probabilities can be adjusted accordingly at any time without requiring re-training of the PNN.

The mathematical foundations of the PNN and GRNN models, and in particular of Parzen's method of estimating probability density functions from per-sample weight functions, are described more thoroughly in Timothy Masters, “Advanced Algorithms for Neural Networks,” John Wiley & Sons, Inc., 1995, incorporated herein by reference. These kernel-based models work by estimating the underlying probability density functions of the data used to train the neural network. The estimated univariate density function of a single population of size N is given by

$$g ( x ) = \frac{1}{N σ} {\sum }_{n = 1}^{N} W ( \frac{x - {x}_{n}}{σ} ) .$$

The training cases are represented by xₙ and the unknown case is represented by x. The term W is a weight function, or “kernel,” normally chosen to be the Gaussian distribution. The density function is easily generalized to the multivariate case. In a univariate case, the kernel width σ is the only undetermined value needed to create the PNN. In a multivariate case, different kernel widths can be assigned for each input feature: σ_{ƒ}.

A PNN's topology is defined by its training cases. Each training case consists of particular input values and corresponding output values. Output values can be used to classify input states into different groups or classes. In the case of a system that generates continuous output values such as a GRNN, classes can be defined in terms of thresholds and ranges of possible output values. In terms of topology, a PNN contains one node in the input layer for each input variable. The PNN contains one node in the pattern layer for each training case, wherein each training case contains a set of particular input feature values and associated output value(s). The PNN contains one node in the summation layer for each class of training cases. In many of the embodiments described herein, the neural network comprises two event classes, a first event class describing the event of interest (e.g., seizure) and a second event class describing all other activity (e.g., not-seizure). It is important to note that a neural network may comprise multiple (three, four, etc.) event classes and therefore the description of the first and second event classes should not be construed as limiting.

Thus, in contrast to an MLP neural network, the topology of a PNN is based solely on the training cases themselves, meaning that PNN construction can be automated once a set of training cases is defined. In addition, adding new training cases to a PNN is a simple process wherein the new training case nodes are merely added into the existing PNN topology. In contrast, an MLP neural network presented with new training cases must retrain on both the new cases and old cases in order to incorporate new cases into the network's prediction capabilities, as described above.

In classification systems where an output value is used to classify input states, an incorrect classification or “prediction error” occurs when the system generates the wrong output value (i.e., corresponding to the wrong class) for a particular input state. A training case that, once incorporated into the classification system, causes the system to subsequently generate the correct output value (corresponding to the correct class) is said to “correct” the prediction error. Because PNN's support fast learning, when a new training case is created to correct a prediction error, a PNN can incorporate the new training case by the trivial operation of simply adding a new pattern layer node (the creation of a pattern layer node from a training case is also trivial). This allows the PNN to be reconfigured to generate the correct output value without any significant computational expense such as retraining. In the case of a GRNN, a prediction error refers to an output value in the wrong range for a particular input state; a training case that, once incorporated, causes the GRNN to generate an output value in the correct range for that input state is said to correct the error. A classification system that is “incapable” of correctly classifying a particular input state means one that would generate the wrong output value for that particular input state, if that input state were input for classification.

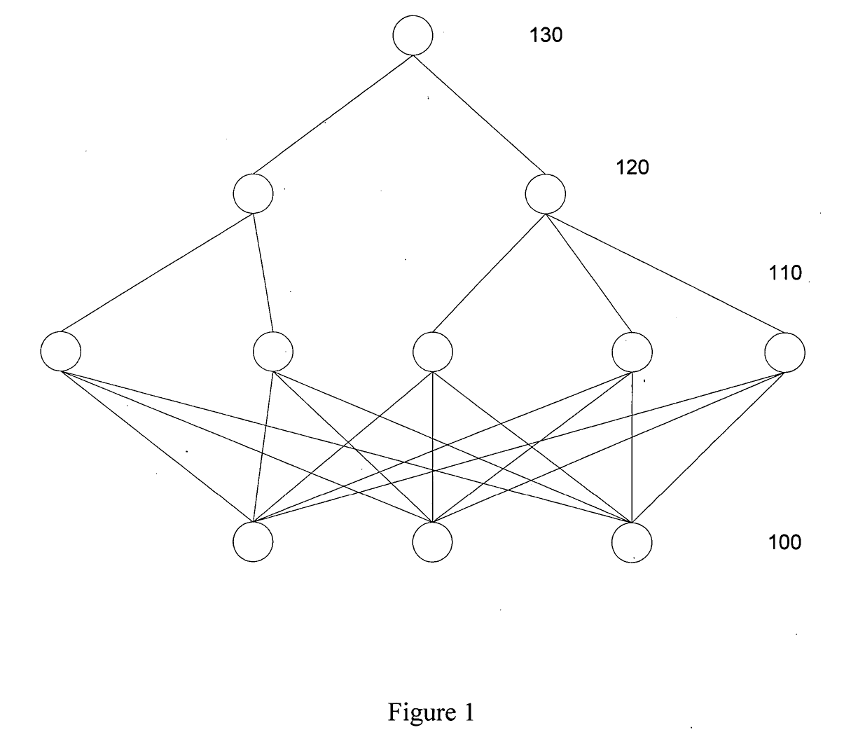

FIG. 1 is a diagram illustrating the topology of a PNN. As shown, the PNN includes an input layer 100, a pattern layer 110, a summation layer 120, and an output layer 130. As shown, three inputs nodes make up the input layer 100. The pattern layer 110 takes its inputs from the input layer 100 and contains five nodes or training cases. The pattern layer 110 of the PNN contains one node for each of the five training case. At the summation layer 120, the PNN contains a pair of event class nodes representing positive and negative cases of the particular event being detected. As shown, three training cases are associated with a positive class node while the remaining two training cases are associated with the negative class node.

Once the topology of the PNN is defined, or more specifically, once the training cases are collected, the PNN is further parameterized only by the value sigma. Sigma determines the width of the kernel used to represent each training case, described above. A large value of sigma gives each training case a large sphere of influence while a small sigma results in a small sphere of influence. While sigma can be adjusted to optimize specific criterion, the main attribute that determines the classification of a new case is its proximity, often the Euclidean distance, to previously classified training cases stored in the pattern layer. If there is a single training case in extremely close proximity, then the new case will likely be assigned to same class regardless of the value of sigma. Sigma, however, does affect the classification result in more ambiguous cases, for example if a new case is somewhat close to two patterns of Class1 but only slightly further away from three patterns of Class2. In such an example, a small value of sigma might cause the new case to be classified as Class1 whereas a large value of sigma might cause the new case to be classified as Class2.

Sigma may be chosen for univariate data with a standard distribution as σ≈1.06 sn^{-1/5}, where s is the standard deviation of the data and n is the number of training cases. To avoid the computational cost of training to calculate an optimal value of sigma, simple heuristics based on population statistics such as “reference to a standard distribution” (Silverman, noted below) can be used to approximate sigma. Different heuristics are more or less accurate depending on the population distribution of the training cases. The formula shown above is a recommended approximation heuristic for Standard distributions. For multivariate data σ∝n^{-1/(d+4)}, where d is the number of inputs as explained in Silverman, Density Estimation for Statistics and Data Analysis, 1986, which is fully incorporated herein. Importantly, once a reasonable number of cases have been classified, the optimal value of sigma changes very slowly as new cases are added. Consider the addition of ten new patterns to a PNN with eight inputs and one hundred existing patterns; the optimal sigma varies by only 0.8%. The nature of the PNN is that the new training cases will automatically be incorporated into subsequent predictions, by adding corresponding pattern layer nodes to the PNN, without the need for expensive computation such as recalculating an optimal sigma. The properties of sigma discussed above mean that a trained PNN, wherein an optimal sigma has been determined by training, can add many training cases and still perform close to optimally, using the same value for sigma throughout. Put differently, a PNN can incorporate new training cases by making predictions that take the new training cases into account, without retraining and still yielding highly accurate predictions. Adding a new training case to the PNN further refines the knowledge of the neural network. Adding a new training case without retraining does so in a time efficient manner. A more detailed description of a PNN and its execution may be found in Timothy Master's Advanced Algorithms for Neural Network, A C++ Sourcebook, which is fully incorporated herein.

1. Overview of the PNN Construction

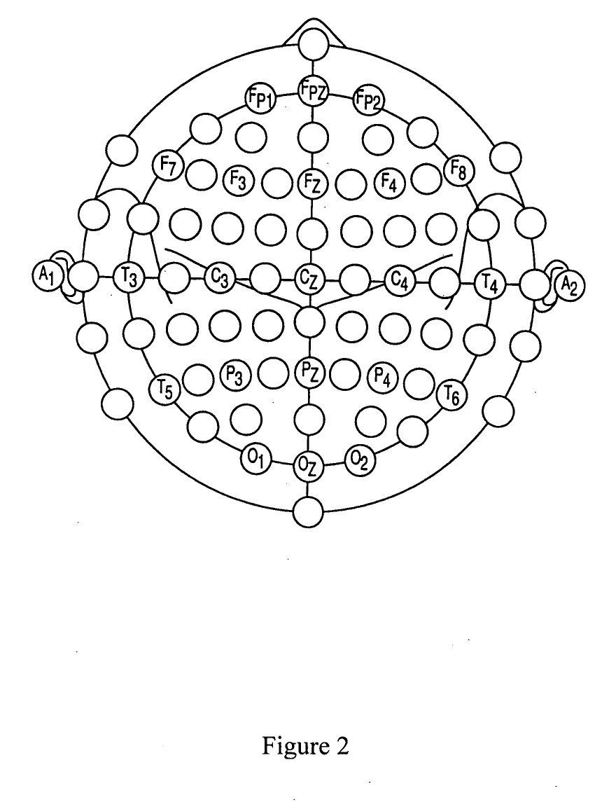

Turning now to utilizing PNN's to detect biomedical patterns, we begin by describing the data collected and used in the construction of the PNN. One of the most complicated biomedical signals is the EEG. Electroencephalograms (EEG's) have been employed to record electrical signals generated by different parts of the brain. In a typical EEG, a plurality of electrodes are placed across the scalp of a patient with predetermined spacings. FIG. 2 is a diagram illustrating a classic arrangement of EEG electrodes positioned on the scalp of a patient along standard lines of measurements. Voltages measured across predetermined pairs of electrodes, for example, C3-F3, F3-F7, F7-T3, T3-T5, etc., are measured simultaneously and recorded as waveforms over a long periods of time. Such simultaneous recording of voltage waveforms across different pairs of electrodes is commonly referred to as a montage. The voltage waveform across a given pair of electrodes in the montage of an EEG recording is commonly referred to as a channel.

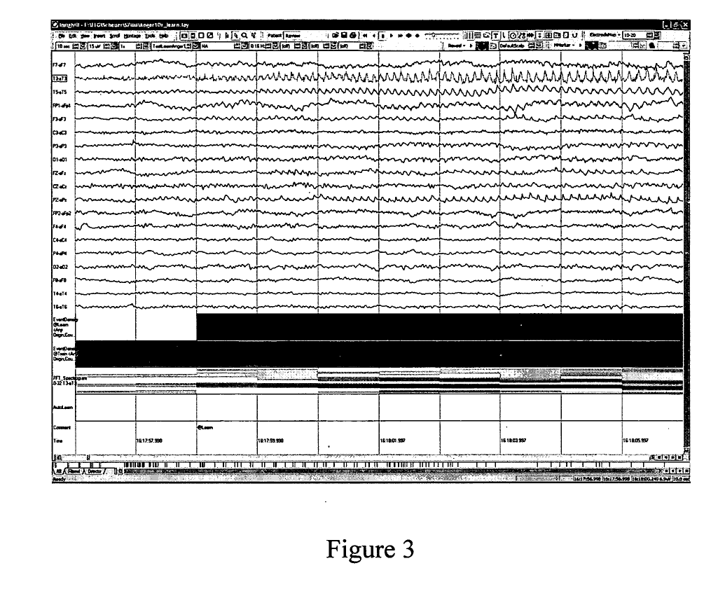

FIG. 3 is a screenshot from the present inventions diagnostic software program that depicts a typical montage of an EEG recording with nineteen channels of simultaneous waveforms recorded over a given period of time. As shown, a first waveform 310 is a voltage waveform measured between electrode F7 and an average reference aF7, created by averaging the voltages of neighboring electrodes Fp1, F3, C3 and T3 in FIG. 2. The remaining channels, T3-aT3 to T6-aT6, measure similar voltages on other parts of the head. The spacing between immediately adjacent vertical lines in the EEG recording of FIG. 3 depicts an interval of one second. Therefore, a total of ten seconds is displayed in the screenshot.

a.) Instruments as PNN Inputs

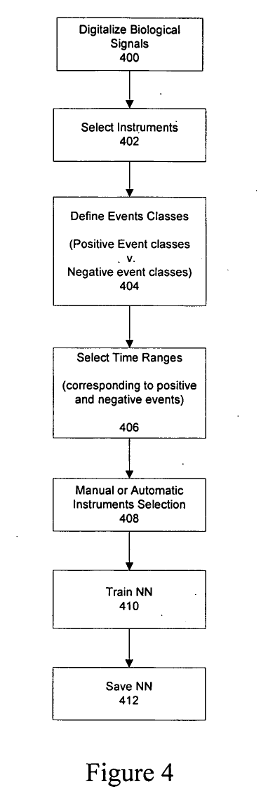

As explained in more detail with respect to FIG. 4, the PNN topology is defined by selecting particular time ranges and instruments from a record of instrument values over time, and further by indicating the events that correspond to the selected instrument values. FIG. 4 is a flow chart illustrating the method of constructing a PNN from biomedical information that is capable of real-time incremental learning. The construction of the PNN begins with the digitalization of biological signals and selection of instruments as respectively shown in steps 400 and 402. Instruments analyze and manipulate the signal information provided by the EEG into data values, all of which are potential inputs of the neural network. In FIG. 4, the instruments used to analyze and manipulate the EEG information into input values are manually selected by a system user, such as a hospital technician. Alternatively, the instruments may be automatically selected by an algorithm as further described below.

An instrument can comprise a variety of analysis tools used to describe, for example, EEG signals. Raw instruments represent the underlying raw data, from which all other instrument values are derived, and which cannot be reconstructed if absent. Each instrument provides a different quantification or transformation of the raw instrument data (e.g., EEG signals), thereby producing various data values that can be used as inputs to the neural network. Such instruments include, but are not limited to the FFT Power, FFT Spectrogram, Auto and Cross Correlation, Coherence, Discrete Wavelet Transform, Continuous Wavelet Transform, and Bispectrum. Instruments can comprise a raw data signal or algorithmic transformations of such data. Additionally, instruments can comprise linear and non-linear combinations of other instruments, identify when a threshold is exceeded, average values over time, and other computations. As described below, an instrument can serve as a filter for the neural network or another instrument, limiting the portions of the record that are presented downstream. An instrument can also be another neural network, such that one neural network's output values are another neural network's instrument features.

Some instruments can generate multiple output signals. Each discrete output signal of an instrument is a referred to as a “feature.” The term “input feature” refers to a feature which is actually used or selected as a neural network input. In terms of neural network topology, the neural network inputs are a subset of the set of all available instrument features. For example, a feature can be an instrument. Or an instrument can comprise multiple features, such as if the instrument generates multiple output signals. For example, in FIG. 3 the “FFT Spectrogram” instrument generates a separate output for each 1-Hz frequency range in the range 0-32 Hz. Each of the FFT instrument's 32 outputs is a separate feature, and, if selected, each is represented in a PNN as a separate input node. The PNN in this case uses a multivariate density function because there are multiple inputs. If only a single instrument feature is selected, such as the “FFT Power” instrument for the specific frequency band 8-12 Hz, then the PNN uses a univariate density function. A particular set of corresponding input feature values (i.e., the values of the respective input features at a particular point in time) is referred to as an “input state.” A training case consists of an input state and its corresponding output value(s).

b.) Selecting Events to Define Summation Layer Class Nodes

Given a record of instrument values over time, a user can mark the record to select the values of particular instrument features during particular time ranges. A record can comprise historical data. Alternatively, a record can comprise live data that accumulates continuously on a real-time basis, such as when the system is “predicting” (detecting) seizures within live EEG signals and instruments based on those signals. Alternatively, a record can comprise a set of time epochs that is a subset of another record.

For example, upon reviewing the EEG display, a user may observe interesting brain activity or patterns. In step 404, the interesting activity can be differentiated from the non-interesting activity by creating two event class nodes at the PNN summation layer. A positive event class represents interesting patterns for future recognition while a negative event class represents all other activity. For example, the user can identify seizure activity by designating a range of interesting activity on the EEG and assigning this activity to a positive event classification. Similarly, background activity is highlighted on the EEG as non-interesting activity and assigned to a negative event classification.

The term “input state” is used to refer to the set of neural network input values that corresponds to a particular time epoch, or moment in time. Instrument values, neural network input values, and neural network output values are all parameterized on time epochs. While each input state corresponds to a single time epoch, the input feature values within that input state may in fact be derived from portions of the record at other, different time ranges.

An instrument can be derived from the values of other instruments, at the same or different time epochs. For example, the value of instrument A at time T can be defined to be the sum of the values of instruments B and C each at time T minus two seconds. Each instrument is potentially an arbitrary transformation of the values of other instruments at other (relative or absolute) times. The range of times from which an instrument draws its input values for a particular time epoch is referred to herein as the instrument's time domain.

The durations and relative positions of time domains, even for instrument values that nominally correspond to the same time epoch, can vary on an instrument-by-instrument basis. In other words, a single input state (nominally corresponding to a single time epoch T) may actually be based not only on many different instruments, but also on many different ranges of time within the record of instrument feature values. Put differently, an instrument feature is an arbitrary function that returns a single value for a given moment (time epoch) T, but which may directly or indirectly be calculated or derived from portions of the record and ranges of time that may not even include T.

Alternatively, in some embodiments all instruments have well-defined and uniform time domains. For example, in one embodiment the record of instrument values is cleanly divided into non-overlapping contiguous one-second blocks, and the time domain of each instrument is the one-second range starting with the time epoch T and ending one second later. In this embodiment, each instrument value at a given time epoch is based on the same 1-second time range. In the case where instruments have different sample rates, instruments can be upsampled or downsampled to achieve a common duration.

New input features can later be added to an existing neural network, by adding new input nodes and by augmenting existing training cases (pattern layer nodes) with the input feature values corresponding to the new input features based on a stored record of historical values of raw instruments. The raw instrument data that “corresponds” to a particular instrument at a particular point in time consists of all of the raw instrument feature values on which the instrument depends either directly or indirectly (e.g., an instrument could depend on another algorithmic instrument which depends on a set of particular raw instrument values). The raw instrument data that “corresponds” to a particular training case consists of all of the raw instrument data (i.e., portions of the record) depended on by all of the instrument feature values in that training case. To be safe, and to account for the possibility that a new instrument feature could be added later that depends on different relative time durations than the current input features, the entire record of raw instrument feature values can be recorded. The corresponding values of other instruments, such as algorithmic instruments, can then be derived by applying the algorithmic instruments to the raw instrument values.

Time domain alignment, meaning the relative starting point and duration of the portion of the record processed by an instrument, can be critical for some instruments. Certain patterns if broken up across time domain boundaries can be undetectable.

Some instruments generally, and in particular using certain instruments to detect certain patterns in the record, are not sensitive to alignment. Instruments such as FFT Spectrogram, FFT Power, and Bispectrum are useful for finding events that are repetitive and long-lived, meaning that the critical signal characteristics repeat frequently and are easily captured regardless of where the time domain falls within the pattern. Two such examples are seizures, measured with the FFT Spectrogram, and strokes, measured with the Alpha/Delta power ratio. Given 10-seconds of constant 7 Hz activity, an FFT Spectrogram of a 1-second epoch produces the same outputs whether the epoch is measured from 1.0 to 2.0 seconds or 1.3 to 2.3 seconds.

Time domain alignment impacts the neural network's ability to recognize certain patterns. A misplaced domain boundary that divides a key signal pattern between two epochs could result in a false negative. For example, some events are characterized by particular frequency components that occur in a particular sequence, such as an epileptic spike or an ECG heartbeat. Such events are typically characterized by a spike followed by a slow wave. The reverse pattern, a slow wave followed by spike should be distinguishable. A standard FFT instrument could not distinguish between these two patterns because the FFT output does not reflect the relative order of the frequency components. Instruments such as Discrete Wavelet Transform (“DWT”) and Matching Pursuit, however, explicitly describe the relative position of the various frequency components within the domain, and are therefore capable of distinguishing the two patterns above. Domain alignment is critical, though, as both frequency components (the spike and the wave) must be enclosed in a single domain (sample) for the pattern to be detected. For example, the DWT instrument could be registered such that (a) it is applied to every spike and (b) its domains start a fixed distance before the spike to ensure that the whole pattern will be detected if present.

An instrument can further customize its time domains by defining epoch-relative parameters such as offset and duration. For example, one instrument might create a 10-second domain starting 5 seconds before each spike, while another instrument might create a 5-second domain starting 1 second before each spike.

Registered events can be used for both alignment (indicating the start and end of time domains) and filtering (indicating which portions of the record to analyze and which to skip). The identification of registered events is performed by a registration instrument, which outputs discrete “anchors” (epochs) that can be used in aligning time domains. Registration instruments can be used to parameterize (i.e., as inputs to) other instruments. For example, rather than processing the entire record, one instrument might operate only on the registered events emitted by a registration instrument. In this case the registration instrument acts as a filter. Similarly, the neural network can operate on registered events emitted by a registration instrument.

In an alternative embodiment, the PNN can be applied to a subset of the record of instrument values rather than to the entire record. For example, a registration instrument can be applied to a record of instrument values to create a set of registration events which is a subset of the original record. In this way, a registration instrument having lesser computational complexity than the PNN itself, can identify time epochs having a high probability of containing interesting activity, such that the more expensive PNN is applied to only the high-probability time epochs rather than to the whole record of instrument values. A registration instrument can therefore be used to filter a record of instrument values before a PNN is applied to them. With respect to user-interactive training of the PNN, a registration instrument can make it easier for a user to identify training cases by automatically highlighting time epochs that, for example, fit a particular waveform template. With respect to automatic event detection by the PNN, a registration instrument can reduce the computational resources required by the PNN, by limiting the portions of the record to which the PNN is applied.

Use of a registration instrument as a filter can allow faster processing because the number of epochs at which the feature instruments and the neural network are computed can be dramatically reduced. Accordingly, a registration instrument can be inserted upstream when the computation complexity of the detection system reaches a threshold, such as when the neural network reaches a predefined number of training cases, to reduce the computational requirements of the overall system.

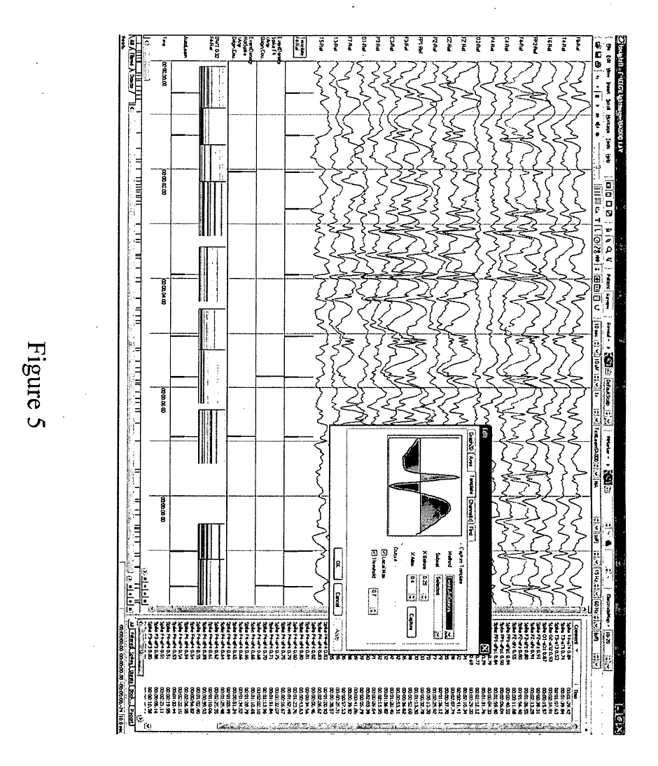

FIG. 5 is a screenshot illustrating the use of a Template instrument for registration of spikes in a record from an epilepsy patient. As shown, the Template curve 502 shown in the dialog box labeled “Edit” is created by averaging the “Spike F4” 504 user marks shown in the Comment List. The “Template F4-Ref” instrument 506 calculates the autocorrelation between the template curve 502 and the F4-Ref channel. Points with an autocorrelation extrema greater than 0.7 are noted as registration times as indicated by an instrument value of 1 rather than 0. The DWT instrument, which is displaying the first 32 coefficients of the wavelet, is attached to this registration instrument so that it only calculates epochs at the registration times. In this embodiment, the registration instrument acts as a filter for the neural network, meaning that the neural network only makes predictions for the registration times rather than for the whole record.

Other types of registration instruments may employed without loss of generality. For example, an instrument that identifies local extrema can be used. Use of a registration instrument allows faster processing because the number of epochs at which the feature instrument(s) and the neural network must be computed is dramatically reduced. Further, the registration instrument allows discrete, registered times to be presented to the user which enhances visual review and correction of incorrect predictions.

c.) Defining Pattern Layer Training Cases Using Select Time Ranges

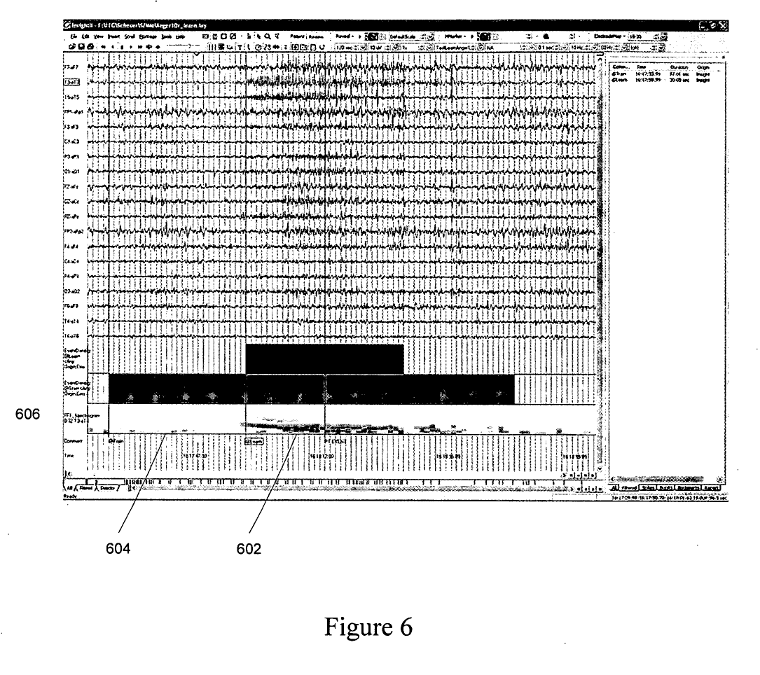

Returning now to the overview illustrated in FIG. 4, upon defining the event class nodes, the training cases are defined by selecting time ranges as illustrated in step 406. Specifically, two time ranges, identifying positive and negative occurrences of the same event are marked. For example, if the event to be detected is seizures, the positive event time range consists of times when a seizure is occurring (the “seizure section”), and the negative event time range consists of times when a seizure is not occurring (the “background section”). FIG. 6 is a screenshot of the software program configured to create a PNN topology through the selection of instruments (step 402 of FIG. 4), events (step 404 of FIG. 4), time ranges (step 406 of FIG. 4). As illustrated, the 30-second positive range (“@Learn” 602) range identifies time epochs when a seizure is occurring. The 77-second negative range (“@Train” 604), minus the 30-second positive range that it encompasses, identifies the time epochs when a seizure is not occurring.

As further illustrated in FIG. 6, the selected FFT instrument 606 actually consists of 32 features, corresponding to one-hertz ranges within the frequency range 0-32 Hz (i.e., the FFT instrument 606 generates separate measurements for each range 0-1 Hz, 1-2 Hz, . . . 31-32 Hz). Thirty-two input nodes are created, one for each FFT feature. The selected time range is divided into (77) one-second epochs. Each one-second epoch becomes a training case, represented by one training case node.

The first training case node contains the 32 FFT instrument 606 values in second 1, the second training case node contains the 32 FFT instrument 606 values in second 2, and so forth. The 30 training case nodes corresponding to epochs in the “seizure” (i.e., “@Learn” 602) time ranges are connected to the positive “seizure” event class node. The 47 training case nodes corresponding to epochs in the “not a seizure” (i.e., “@Train” 604) time ranges are connected to the negative “not a seizure” event class node.

d.) Training the Neural Network

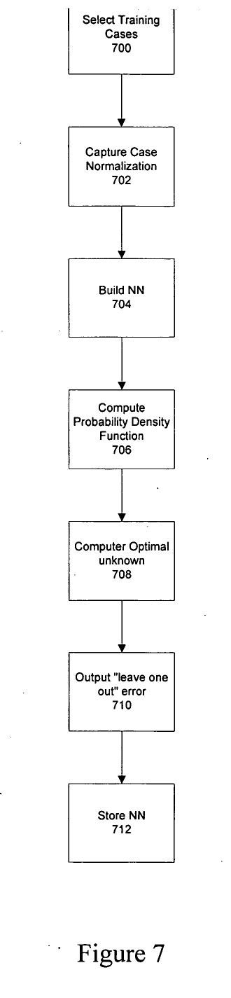

FIG. 7 is a flow chart describing the neural network training process set forth in step 410 of FIG. 4. In step 700, training cases are selected. As described above, the training cases may be created by the outputs of the instruments and the selected time ranges. One training case may be created for each epoch. Upon selecting the training cases, the standard deviation of each input node may be optionally calculated from the training cases and used to normalize the training cases as depicted in step 702. Depending on the method used to determine sigma, the normalization may benefit the optimization process. In step 704, the neural network is built. The optimal value of a is computed in steps 706 and 708. Specifically, in step 706, a global search to minimize the network error over a reasonable range (0.003-1.0) is performed. In step 708, the optimization uses the rough minimum found via the global search as the starting point for the golden section method. Once the optimal σ is calculated, this value is used in step 710 to calculate σ_{ƒ}. Alternatively, other methods may used to calculate σ_{ƒ} such as reference to a standard distribution, least-squares cross-validation or likelihood cross-validation each of which are fully described in the Silverman reference noted above. An output of this optimization is the final “leave one out” error. This error, also used to guide the optimization, is computed by testing the output of the neural network with the training cases, but when a case is tested, the corresponding case in the Pattern layer is removed. This allows the neural network to be created without dividing the case data into training and test cases. This is especially advantageous in situations where few cases are available. The completed neural network is ultimately stored for later use in step 712.

Referring back to FIG. 4, it is important to note that in the course of defining training cases, a user can select a particular configuration or subset of instruments to be used for prediction, out of the set of all instruments available. In the construction of the PNN, the selected configuration of instruments defines the number and nature of the input nodes. Selecting particular instruments manually, as shown in step 408, can be performed on the basis of visual observation, such as by observing that a particular instrument's measurements demonstrate distinctive behavior during the training cases selected.

In another embodiment of the present invention, the configuration of instruments to be used can be selected automatically. In addition, where an initial configuration of instruments is guessed or picked manually, an optimal configuration of instruments can subsequently be determined automatically. The method utilizes a metric to rank the effectiveness of a particular PNN in classifying the training cases it is based on. Example metrics include but are not limited to the network error, the classification error and the Bayesian Information Criterion (BIC). Accordingly, by constructing multiple PNN's based on the same training cases (i.e., time epochs) but different configurations of instruments, the respective metrics for each PNN can be used to determine which instrument configuration is the most optimal. More generally, after a set of training cases is defined in terms of time and class, the optimal configuration of instruments can be determined by iterating through every possible configuration of instruments and measuring the metrics of the resulting PNN's. In the current implementation, the method minimizes the classification error.

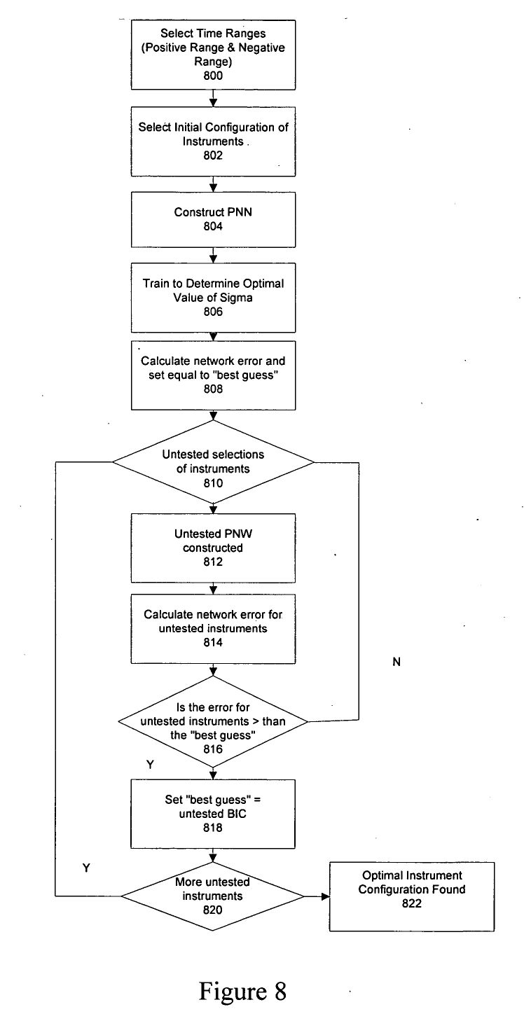

FIG. 8 illustrates a method of determining an optimal configuration of instruments from a set of available instruments. First, in step 800, a positive time range and negative time range are selected. Next, in step 802, an initial configuration of instruments is selected as the “best guess” configuration. Next, in step 804, a PNN is constructed based on the time ranges and “best guess” configuration. Next, in step 806, the PNN is trained to determine the optimal sigma value. It is important to note that alternatively, sigma might be picked arbitrarily, as having a value of 0.1 (i.e. sigma could be a constant value across all tested configurations). Next, in step 808, the metric, such as the network error of the PNN is calculated, and a “best guess” error value is set to this value.

Next, in step 810, an untested configuration of instruments is selected. Next, in step 812, an untested PNN is constructed based on the selected time ranges and the untested configuration. Next, in step 814, the network error is calculated for the untested PNN. Next, in step 816, if the untested network error is less than the “best guess” error, then in step 818 the “best guess” configuration is set to be untested configuration and the “best guess” error is set to be the untested error. Next, in step 820, if any untested configurations remain, system returns to step 812. Otherwise, in step 822, if no untested configurations remain then the current “best guess” configuration is the optimal configuration.

2. Creating a Robust Detection PNN

a. Incremental Learning

As discussed above, PNN's benefit from the characteristic that the optimal value of sigma varies little over training set sizes. Thus, training cases may be incrementally added to the PNN, further adding to its recognition capabilities, without having to train the PNN on the new cases or re-train the PNN on the old cases.

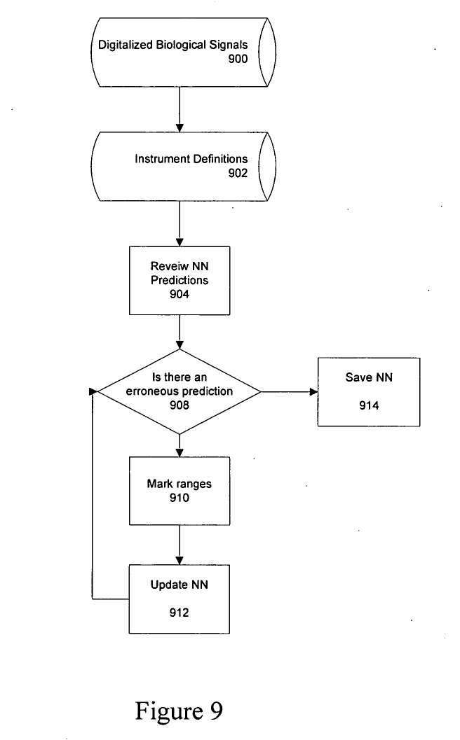

FIG. 9 is a flowchart indicating the steps used during incremental learning. In steps 900 and 902, the instruments and neural network are loaded into the computer upon completion of its construction. In step 904, the user visually reviews the predictions of the displayed neural network. If an erroneous prediction (i.e., a false positive or a false negative) is noted as illustrated in step 908, the PNN may be incrementally updated as described and illustrated with respect to FIG. 9.

To incrementally update the PNN, the user selects the epochs that generated the erroneous prediction and marks the selection with the correct class designation (e.g., a false positive is marked with “not a seizure”) as illustrated in steps 910 and 912. One or more new training cases are thus created from this information. The training cases are new nodes containing the instrument values corresponding to the selected epochs. In this instance, the new training case nodes would be attached to the existing “not a seizure” class node. When erroneous predictions are not found in step 908, the neural network is saved as shown in step 914.

Turning now to the properties of the neural network, a more robust detection neural network may be achieved by compressing the neural network or combining the neural network with other neural networks.

b. Updating the Neural Network

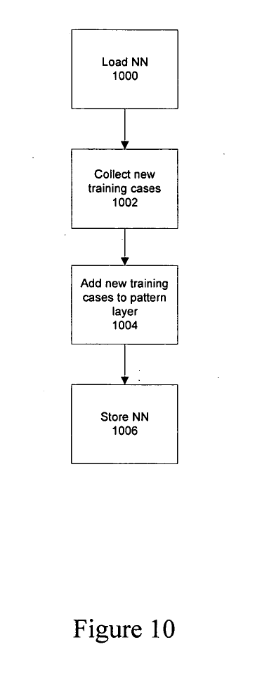

Looking now at FIG. 10, a flow chart illustrating the process of updating the neural network is displayed. In step 1000, a previously stored neural network is loaded. In step 1002, the new training cases, identified in the incremental learning process described with respect to FIG. 9, are collected. The new training cases are added to the pattern layer of the neural network in step 1004. This process is essentially instantaneous. In most cases, the neural network will not benefit from readjusting σ_{ƒ}, but this could be done. The updated neural network is stored for later use in step 1006.

c. Compressing the Neural Network

If the prediction speed of the neural network becomes too slow due to the size of the pattern layer (e.g., more than 10,000 patterns), the neural network can be compressed. The main idea is that similar patterns can be merged and described by their centroid and weight. One compression method is described by Babich & Camps, “Weighted Parzen Windows for Pattern Classification,” 18 IEEE Trans. Pattern Analysis 5, incorporated herein by reference. An alternate and improved compression method may be employed wherein each pattern is described by its centroid, weight and covariance matrix. This method is described in a reference by Fraley and Raftery entitled, “Model-Based Clustering, Discriminant Analysis, and Density Estimation,” Technical Report No. 380, Department of Statistics, University of Washington, October 2000, which is fully incorporated herein by reference.

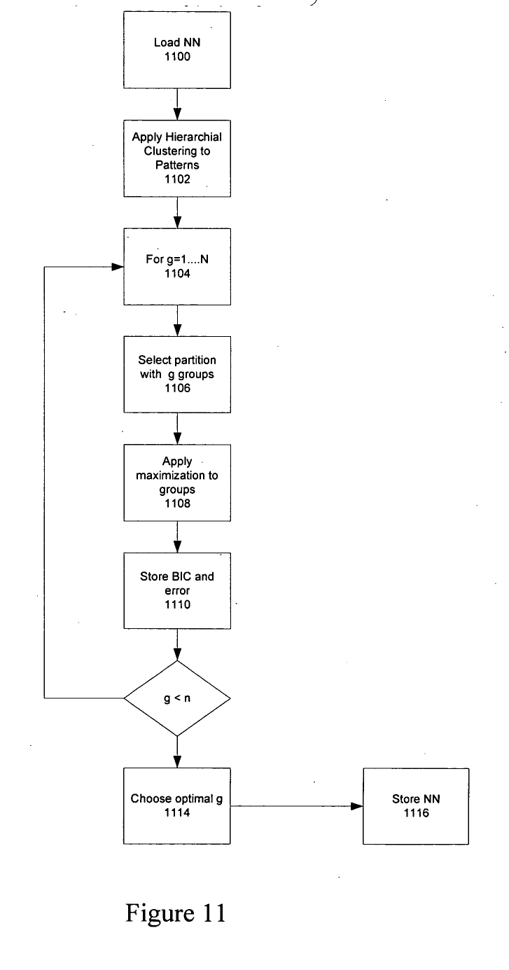

FIG. 11 is a flow chart illustrating the neural network compression process. To begin, a previously stored neural network is first loaded in step 1100. In step 1102, the patterns in the neural network are hierarchically clustered. Hierarchical clustering is described in the reference by Jain and Dubes, entitled “Algorithms for Clustering Data” Englewood Cliffs, N.J. Prentice Hall, 1988., which is hereby incorporated by reference. By way of brief introduction, if there are N patterns in the neural network, then the hierarchical clustering produces partitions with 1 . . . N groups as illustrated in step 1104. Thus a loop begins where g=1 . . . N and where the partitions are compared to find the best one. In step 1106, the partition with g groups is selected. The expectation-maximization algorithm is then applied to the partition to compute the centroids and co-variances of the groups as depicted in steps 1108. The clustered neural network is tested and the Bayesian Information Criterion (BIC) and the respective errors are recorded in step 1110. The loop termination condition is tested in step 1112. The optimal number of groups is chosen heuristically using the BIC, error and compression ratio in an attempt to balance the compression versus loss of accuracy as depicted in step 1014. The current implementation maximizes the BIC found when 1 to 20 groups are used. The compressed neural network is stored for later use in step 1116.

d. Combining Neural Networks

It may be desirable to combine two neural networks. For example, a seizure detection neural network is developed at Site A, and sent to Sites B and C for use and testing. Each of sites B and C independently updates the neural network, such as by correcting poor predictions, and returns its updated neural network to Site A. The two updated neural networks (B and C) can be combined to create an even more robust neural network, which can then be redistributed by Site A.

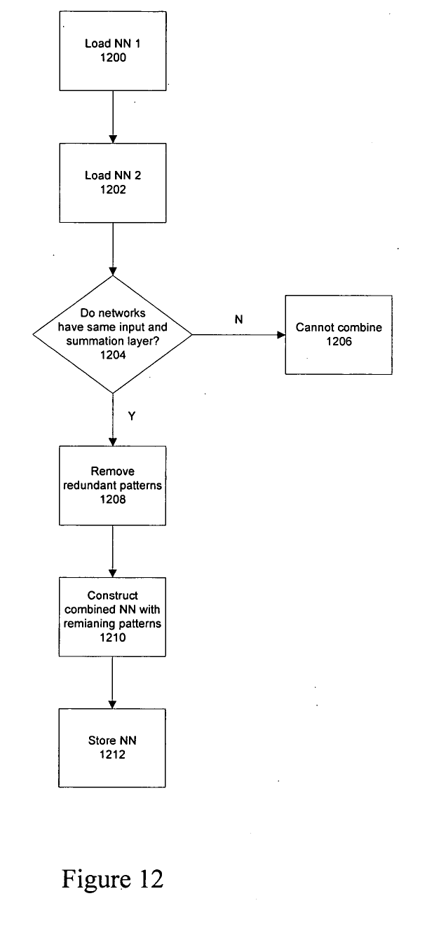

FIG. 12 is a flow chart depicting the process of combining two or more constituent neural networks into a combined neural network. In steps 1200 and 1202, the neural networks are loaded. In step 1204, the neural networks are compared to verify that they have the same input and summation layers, thereby ensuring that the neural networks can be combined. If the neural networks do not have the same input and summation later, then they cannot be combined as depicted in steps 1206.

If the neural networks have matching summation and input layers, then the redundant patterns (training cases represented by pattern layer nodes) can be removed as depicted in step 1208. Alternatively, the redundant patterns can be included such as where extra weighting of redundant patterns is desirable, it is known that the two neural networks do not share common data, or the user otherwise specifies. For example, if the two neural networks to be combined are descendants of a common parent neural network, they could contain patterns that are duplicate copies of patterns present in the parent neural network, in which case one can be removed as redundant. For another example, multiple users could review the same record to select training cases, and then combine their selections to form a consensus neural network, in which case the duplicate patterns represent the same underlying data (the same parts of the same record) but should be kept to represent the weighting of the multiple user markings. In contrast, two neural networks could contain an identical pattern but where each was independently derived, in which case the two patterns represent independent data and neither should be removed. If one of the constituent neural networks is compressed, combining it with another neural network could require that the original uncompressed patterns (training cases) be available in order to correctly filter redundant patterns. The combined neural network is constructed by copying the input and summation layers from the first neural network, and adding the remaining, non-redundant, patterns to the pattern layer as shown in step 1210. The combined neural network is stored for later use in step 1212.

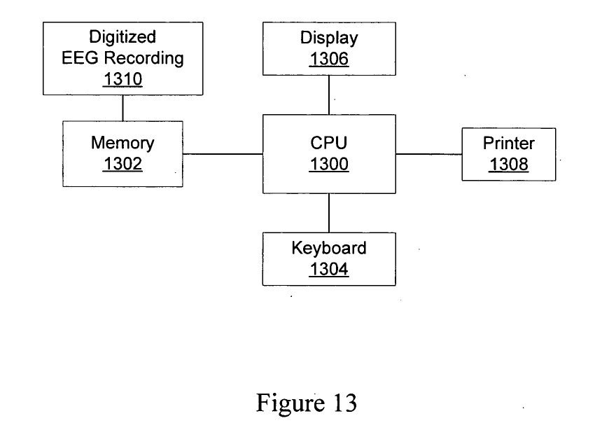

FIG. 13 is a block diagram illustrating a computer system or an article of manufacture for processing biomedical signals according to embodiments of the present invention. As illustrated in FIG. 13, the computer system includes a central processing unit (CPU) 1300, a computer readable medium such as a memory 1302, an input device such as a keyboard 1304, and output devices such as a display monitor 1306 and a printer 1308. The digitized EEG recording 1310 is read into the memory 1302 for processing by the CPU 1300, which is capable of running a computer program code comprising instructions for performing process steps that include digital signal processing, neural networks, and hierarchical clustering according to embodiments of the present invention.

3. Industrial Applicability

Although neural networks are extremely advantageous, the time frame between collecting data and transforming that data into a usable context is extremely long and cost inefficient. The above described invention eliminates this problem by providing a system and method that allows a neural network to incrementally learn in real time by processing only new training cases as opposed to the conventional method that required the reprocessing of all training cases contained in the neural network. An advantageous implementation of this incremental learn capability is that a community of distributed users can now instantaneously create an optimal neural network by sharing training cases.

In one embodiment employing a distributed network, a first user may update its respective neural network based on a training case created by a second user. Take, for exemplary purposes only, a medical hospital having multiple computers equipped with the necessary hardware and software for implementation of the present invention, wherein each computer may contain a neural network for identifying seizures. For instance, while monitoring a patient, a first user creates a training case by selecting instrument feature values and associating them with particular output values as described in detail above. Upon creating the training case, the first user reconfigures the neural network in real time based on the training case. The first user then transmits the training case to a second user. Upon receipt, the second user reconfigures their respective neural network in real time based on the training case identified by and transmitted from the first user. As such, the real-time reconfiguration allows the neural networks maintained by both the first and second users to immediately identify the biomedical state associated with training case.

The training case may be provided from any source including but not limited to multiple users in distributed locations, or downloaded off the Internet. It is also important to note that training cases may be shared over any distributed environment and therefore should not be limited to a local area network as utilized in the present example. Rather, the distributed environment includes, but is not limited to WANs (wide are networks), the Internet, wired and wireless networks.

In another embodiment of the present invention, a client server architecture can be utilized to create and enhance a centrally stored neural network. For exemplary purposed only, a neural network capable of identifying a seizures is stored in a central distribution authority. The distribution authority and the client detection modules are coupled via a network interface such as the Internet. Both the distribution authority and the client detection modules are configured with the necessary hardware and software to perform the incremental update, compression and combination functions as described above.

When a client detection module creates a new training case, the detection module can supplement the neural network stored at the distribution authority by transmitting the training case, as an update, to the distribution authority. The distribution authority is configured with a filter mechanism to analyze the update in order to avoid misclassification errors. If it is determined that the update will supplement the stored neural network, the distribution authority reconfigures the stored neural network. The distribution authority is then capable of distributing the reconfigured neural network (or the update) to other detection modules. Alternatively, a detection module may request, from that central authority, that the updated and reconfigured neural network be download over the network and onto the requesting detection module after receiving a message from the central authority regarding recent updates to the stored neural network. Importantly, this distributed architecture may be employed via a WANs (wide are networks), the Internet, wired and wireless networks or any network combination thereof.

What is claimed:

1. A method for creating a neural network based on a plurality of training cases, for the detection of medical events from a record of instrument feature values, comprising:
collecting the plurality of training cases, wherein each training case has an input state and a corresponding output value;
constructing the neural network based on the training cases; and
training the neural network.

2. The method of claim 1, wherein the step of collecting the plurality of training cases further comprises:
selecting a plurality of time epochs from a record of instrument feature values; and
indicating an output value for each selected time epoch.

3. The method of claim 2, the step of collecting the plurality of training cases further comprises:
selecting a configuration of instrument features; and wherein the step of constructing the neural network based on the training cases comprises:
defining the neural network topology based on the input values and output values of the plurality of training cases; and
determining a kernel width value.

4. The method of claim 3, wherein the step of training the neural network includes determining an optimal kernel width value by minimizing prediction error of the neural network.

5. The method of claim 4, wherein the step of training the neural network further comprises:
determining an optimal input feature kernel width value for each input feature based on the determined optimal kernel width value.

6. The method of claim 3, wherein the neural network is a probabilistic neural network.

7. The method of claim 3, wherein the neural network is a generalized regression neural network.

8. The method of claim 3, wherein determining the kernel width value is based on a population statistic of the plurality of training cases.

9. The method of claim 8, wherein determining the kernel width value is based at least in part on the mathematical term of the number of training cases raised to an exponent power of about negative one-fifth.

10. The method of claim 9, wherein determining the kernel width value is based on the population distribution of the plurality of training cases.

11. The method of claim 10, wherein the population distribution of the plurality of training cases is approximately Normal.

12. The method of claim 3, further comprising normalizing the input values of the plurality of training cases based on the standard deviation for each input feature, and wherein the step of determining the kernel width value comprises defining the kernel width value to be a number in the range 0.1 to 1.0.

13. The method of claim 3, wherein collection of the plurality of training cases further comprises:
normalizing the input values of the plurality of training cases based on the standard deviation for each input feature.

14. A method for compressing a neural network, comprising:
determining a plurality of partitions based on the pattern layer nodes of the neural network wherein each partition comprises a plurality of groups of pattern layer nodes;
selecting one of the plurality of partitions based on a partition metric; and
for each group of pattern layer nodes within the selected partition:
replacing the group of pattern layer nodes with a compressed pattern layer node; and
adjusting the link weights between the compressed pattern layer node and any summation layer nodes to reflect the number of replaced pattern layer nodes.

15. The method of claim 14, wherein the partition metric comprises determining a BIC value for each partition.

16. The method of claim 15, wherein the partition metric comprises selecting the maximum BIC value.

17. The method of claim 14, wherein the partition metric comprises determining an error value for each partition.

18. The method of claim 14, wherein the partition metric comprises determining a compression ratio for each partition.

19. The method of claim 14, wherein the partition metric comprises determining a Minimum Description Length for each partition.

20. The method of claim 14, wherein the partition metric comprises determining a BIC value, an error value, and a compression ratio value for each partition.

21. The method of claim 20, wherein the K-means clustering method is applied to determine a plurality of partitions.

22. The method of claim 20, wherein the hierarchical clustering method is used to determine the plurality of partitions.

23. The method of claim 22, wherein the step of determining a plurality of partitions comprises applying the hierarchical clustering method to create partitions containing between about 1 and about 20 groups.

24. The method of claim 14, wherein selecting one of the determined plurality of partitions based on a partition metric comprises:
determining, for each partition within the determined plurality of partitions, a centroid value for each group of pattern layer nodes within that partition.

25. The method of claim 24, wherein selecting one of the determined plurality of partitions based on a partition metric further comprises:
determining, for each partition within the determined plurality of partitions, a covariance value for each group of pattern layer nodes within that partition.

26. A method for combining a first constituent neural network with a second constituent original neural network, comprising:
determining which pattern layer nodes of the constituent neural networks are redundant;
creating a combined neural network by adding non-redundant pattern layer nodes of one constituent neural network to the pattern layer of the other constituent neural network.

27. The method of claim 26, wherein the second constituent neural network has extra input nodes not present in the first constituent neural network, and further comprising:
adding input feature values to the training cases of the first constituent neural network, wherein the added input feature values correspond to the extra input nodes, based on the raw instrument values corresponding to the training cases of the first constituent neural network.

28. A method for incrementally updating a neural network based on a first training case, comprising:
reconfiguring the neural network based on a first training case without retraining the neural network; and
applying the neural network to detect an event in a record of values.

29. The method of claim 28, wherein reconfiguring the neural network comprises adding a first pattern layer node to the neural network based on the first training case.

30. The method of claim 29, further comprising creating the first training case based on the record of values.

31. A method for incrementally updating a neural network based on correcting a prediction error, comprising:
applying the neural network to generate a first output value based on a first input state;
detecting a first prediction error in the first output value;
creating a first training case based on the first input state wherein the first training case corrects the first prediction error;
reconfiguring the neural network based on the first training case without retraining the neural network; and
applying the neural network to generate a second output value based on a second input state.

32. The method of claim 31, wherein reconfiguring the detection module further comprises adding a first pattern layer node to the neural network based on the first training case.

33. A method for updating a detection module configured to classify input states into event classes wherein the detection module is initially incapable of correctly classifying a first input state, comprising:
creating a training case, by selecting a second input state and associating it with an event class; and
reconfiguring the detection module in real-time to correctly classify the first input state based on the training case.

34. A method for updating a medical event detection module configured to classify input states into classes of medical states wherein the detection module is initially incapable of correctly classifying a first input state, comprising:
creating a training case, by selecting a second input state and associating it with a medical state; and
reconfiguring the detection module in real-time to correctly classify the first input state based on the training case.

35. A method for updating a medical event detection module configured to classify input states into classes of medical states wherein the detection module initially incorrectly detects a first medical state based on a first input state, comprising:
creating a training case, by selecting a second input state and associating it with a second medical state; and
reconfiguring the detection module in real-time to detect that the first input state does not correspond to the first medical state.

36. A method for updating a medical event detection module configured to classify input states into classes of medical states wherein the detection module initially fails to detect a first medical event from a first input state, comprising:
creating a training case, by selecting a second input state and associating it with a second medical event; and
reconfiguring the detection module in real-time to correctly detect the first medical event from the first input state.

37. A method for updating a detection module in real-time based on correcting a classification error, comprising:
applying the detection module to classify a first input state into a first event class;
detecting that the detection module incorrectly classified the first input state into the first event class;
creating a first training case by associating the first input state with a second event class; and
reconfiguring the detection module in real-time based on the first training case.

38. A method for updating a neural network, comprising:
transmitting a training case to a user; and
reconfiguring the neural network based on the training case.

39. The method of claim 38, wherein the user receives the training case from a server.

40. The method of claim 38, wherein the user receives the training case from a remote user.

41. The method of claim 38, wherein the training case is transmitted over a network.

42. The method of claim 41, wherein the network is the Internet.

43. The method of claim 41, wherein the network is a LAN.

44. The method of claim 42, wherein the network is a wireless network.

45. The method of claim 38, wherein the training case is transmitted when the second user downloads the training case from a central network server.

46. The method of claim 38, wherein the reconfiguration of the neural network is accomplished in real time.

47. A method for updating a second neural network, comprising:
creating a training case;
transmitting the training case to a second user; and
reconfiguring a second neural network based on the training case.

48. The method of claim 47, wherein the training case is created by a first user on a first neural network.

49. The method of claim 47, wherein the first user is remotely located.

50. The method of claim 47, wherein the training case is transmitted over a network.

51. The method of claim 50, wherein the network is the Internet.

52. The method of claim 50, wherein the network is a LAN.

53. The method of claim 51, wherein the network is a wireless network.

54. The method of claim 47, wherein the training case is transmitted when the second user downloads the training case from a central network server.

55. The method of claim 47, wherein the reconfiguration of the second neural network using the training case is accomplished in real time.

56. A method for updating a first neural network and a second neural network, comprising:
creating a training case using the first neural network;
reconfiguring a first neural network in real-time based on the training case;
transmitting the training case created by the first neural network to a second user; and
reconfiguring a second neural network based on the training case.

57. The method of claim 54, wherein the first user is remotely located.

58. The method of claim 56, wherein the training case is transmitted over a network.

59. The method of claim 58, wherein the network is the Internet.

60. The method of claim 58, wherein the network is a LAN.

61. The method of claim 58, wherein the network is a wireless network.

62. The method of claim 58, wherein the training case created using the first neural network is stored on a central network server.

63. The method of claim 62, wherein the training case is transmitted when the second user downloads the training case from a central network server.

64. The method of claim 58, wherein the reconfiguration of the second neural network using the training case is accomplished in real time.

65. A method for updating a first neural network and a second neural network, comprising:
creating a training case;
reconfiguring a first neural network in real-time based on the training case;
transmitting the training case to a second user; and
reconfiguring a second neural network in real-time based on the training case.

66. The method of claim 65, wherein the neural network utilized by the second user is remotely located from the neural network used to create the training case.

67. The method of claim 65, wherein the training case is transmitted over a network.

68. The method of claim 67, wherein the network is the Internet.

69. The method of claim 67, wherein the network is a LAN.

70. The method of claim 67, wherein the network is a wireless network.

71. The method of claim 65, wherein the training case created using the first neural network is stored on a central network server.

72. The method of claim 71, wherein the training case is transmitted when the second user downloads the training case from a central network server.

73. A method for updating a first neural network and a second neural network, comprising:
creating a training case;
reconfiguring a first neural network in real-time based on the training case; and
transmitting the training case to a receiving module, wherein the receiving module is configured to reconfigure a second neural network in real-time based on the training case.

74. A method for updating a first neural network and a second neural network, comprising:
receiving a training case from a transmitting module, wherein the transmitting module is configured to reconfigure a first neural network in real-time based on the training case; and
reconfiguring the second neural network in real-time based on the training case.

75. A method for updating a first neural network and a second neural network, comprising:
receiving a training case from a transmitting module, wherein the transmitting module is configured to reconfigure a first neural network in real-time based on the training case; and
transmitting the training case to a receiving module, wherein the receiving module is configured to reconfigure a second neural network in real-time based on the training case.

76. A method for updating a second neural network, comprising:
creating a second training case;
reconfiguring the second neural network in real-time based on the second training case;
receiving a first training case; and
further reconfiguring the second neural network in real-time based on the first training case.

77. A system for updating a neural network, comprising:
a network interface configured to interface the system with a network;
a distribution authority coupled to the network interface, the distribution authority configured to receive an update from a first detection module via the network interface, and store the update;
wherein the update comprises a training case.

78. The system of claim 77, wherein the distribution authority is further configured to transmit the update to a second detection module via the network interface.

79. The system of claim 78, wherein the second detection module is configured to reconfigure a second neural network in real-time based on the update.

80. The system of claim 77, wherein the update further comprises a plurality of raw instrument values corresponding to the training case.

81. The system of claim 77, wherein the distribution authority is further configured to determine whether to store and/or transmit the update.
